(19) United States
(12) Patent Application Publication
(10) Pub. No.: US 2023/0246215 A1
(43) Pub. Date: Aug. 3, 2023

(54) Sintered Anode For Molten Carbonate Fuel Cell

(71) Applicants: EXXONMOBIL TECHNOLOGY AND ENGINEERING COMPANY, Annandale, NJ (US); FUELCELL ENERGY, INC, DANBURY, CT (US)

(72) Inventors: Jonathan S. ROSEN, Niskayuna, NY (US); Gabor KISS, Hampton, NJ (US); Timothy A. BARCKHOLTZ, Whitehouse Station, NJ (US); Lu HAN, Ringoes, NJ (US); William A. LAMBERTI, Stewartsville, NJ (US); William C. HORN, Long Valley, NJ (US); Abdelkader HILMI, Bethel, CT (US); Timothy C. GEARY, Stamford, CT (US); Carl A. WILLMAN, Newtown, CT (US); Adam W. FRANCO, Newtown, CT (US)

(21) Appl. No.: 18/100,536

(22) Filed: Jan. 23, 2023

Related U.S. Application Data
(60) Provisional application No. 63/300,940, filed on Jan. 19, 2022.

(51) Int. Cl. H01M 8/14; H01M 8/0232

(52) U.S. Cl. CPC H01M 8/145; H01M 8/0232; H01M 2008/147

(57) ABSTRACT

Systems and methods are provided for improving the operation of molten carbonate fuel cells that include cathode current collector structures that have reduced contact area with the cathode in order to create increased cathode open surface area. Molten carbonate fuel cells that have cathode collectors with reduced contact area with the cathode can have an increased tendency to suffer structural difficulties during operation, such as formation of gaps between electrolyte and one or both electrodes. Use of a sintered anode in such a fuel cell can reduce or minimize the impact of such structural difficulties. The sintered anode can provide higher pore volume and/or a more stable pore structure and/or increased structural stability in a fuel cell that includes a cathode collector that has a reduced contact area with the cathode. This can maintain a more stable interface between the cathode and electrolyte and/or between the anode and the electrolyte.

### FIELD OF THE INVENTION

A sintered anode for a molten carbonate fuel cell is provided, along with methods for making such a sintered anode and for operating a fuel cell having such a sintered anode.

### BACKGROUND OF THE INVENTION

Molten carbonate fuel cells utilize hydrogen and/or other fuels to generate electricity. The hydrogen may be provided by reforming methane or other reformable fuels in a steam reformer, such as steam reformer located upstream of the fuel cell or integrated within the fuel cell. Fuel can also be reformed in the anode cell in a molten carbonate fuel cell, which can be operated to create conditions that are suitable for reforming fuels in the anode. Still another option can be to perform some reforming both externally and internally to the fuel cell. Reformable fuels can encompass methane and other, higher-carbon (C₂₊), hydrocarbons that can be reacted with steam and/or carbon dioxide at elevated temperature and/or pressure to produce a gaseous product that comprises hydrogen.

The basic structure of a molten carbonate fuel cell includes a cathode, an anode, and a matrix between the cathode and anode that includes one or more molten carbonate salts that serve as the electrolyte. During conventional operation of a molten carbonate fuel cell, the molten carbonate salts wet the cathode walls inside the pores and may also partially fill the pores of the cathode. This diffusion of the molten carbonate salts into the pores of the cathode provides an interface region where CO₂ can be converted (in the presence of O₂) into CO₃²⁻ for transport across the electrolyte to the anode. Similarly, diffusion of molten carbonate salts into the anode provides an interface region where CO₃²⁻ can be converted (in the presence of H₂) into H₂O and CO₂.

In addition to the anode, cathode, and electrolyte matrix, volumes adjacent to the anode and cathode are typically included in the fuel cell. These adjacent volumes allow an anode gas flow and a cathode gas flow to be delivered to the anode and cathode, respectively. In order to provide the volume for the cathode gas flow while still providing electrical contact between the cathode and the separator plate defining the outer boundary of the fuel cell, a cathode current collector structure can be used. An anode current collector can be used to similarly provide the volume for the anode gas flow. These structures can also be referred to as a cathode current collector and an anode current collector, respectively.

Traditionally, molten carbonate fuel cells were used for power generation. When used for traditional power generation, the fuel cells are operated in a relatively narrow window of operating conditions.

More recently, efforts have been made to use molten carbonate fuel cells in applications where carbon capture is at least partially the focus of use, or possibly even the primary purpose for use of the fuel cells. When operating under conditions where the CO₂ utilization in the cathode is high, conventional cathode collector structures can cause difficulties for effectively utilizing CO₂ and/or for maintaining long fuel cell lifetime. At least some of the difficulties related to using conventional cathode collector structures are due to the surface area of contact between the cathode collector and the cathode. In particular, cathode collector structures that have larger areas of contact with the cathode can excessively reduce the cathode surface area that is open for the transport of cathode input gases into the electrolyte. This may not be apparent at high CO₂ concentrations typical in power generation applications, but can create CO₂ capture deficiency in carbon capture applications characterized by low cathode CO₂ levels.

U.S. Patent Application Publication 2020/0176783 describes cathode collector structures that have a reduced amount of contact area with the cathode, and therefore provide an increased open surface area for gas transport from the cathode flow chamber into the cathode pores where the CO₂ can get into contact with the electrolyte in the said cathode pores.

U.S. Pat. Nos. 6,492,045 and 8,802,332 describe examples of other current collectors for molten carbonate fuel cells. The current collectors are typically corrugated structures that have multiple functions, like creating the electrode flow channels, providing an electrically conducting frame for the electrical current between the electrode and the bipolar plates of the cell, and allowing an access of the gases to the electrodes needed for the electrochemical process.

### SUMMARY OF THE INVENTION

In various aspects, a molten carbonate fuel cell is provided. The molten carbonate fuel cell includes a first separator plate. The molten carbonate fuel cell further includes a cathode current collector. The molten carbonate fuel cell further includes a cathode, the cathode current collector providing support between the first separator plate and a first surface of the cathode, an open area of the first surface of the cathode corresponding to 40% or more of the total surface area of the first surface of the cathode. The molten carbonate fuel cell further includes a second separator plate. The molten carbonate fuel cell further includes an anode current collector. The molten carbonate fuel cell further includes an anode having a thickness of 0.30 mm or more and beginning-of-life porosity of 45% or more, the anode current collector providing support between the second separator plate and a first surface of the anode. Additionally, the molten carbonate fuel cell includes an electrolyte matrix having an interface with a second surface of the cathode and an interface with a second surface of the anode.

The molten carbonate fuel cell can further include an alkali carbonate electrolyte, such as an alkali carbonate electrolyte corresponding to Na₂CO₃, Li₂CO₃, K₂CO₃, or a combination thereof.

In various aspects, a method for operating a molten carbonate fuel cell is also provided. The method includes introducing an anode input stream containing H₂, a reformable fuel, or a combination thereof into an anode gas collection zone. The anode gas collection zone can be defined by a first surface of an anode, a first separator plate, and an anode current collector providing support between the anode surface and the separator plate. The anode can have a beginning-of-life porosity of 45% or more and a thickness of 0.30 mm or more. The method can further include introducing a cathode input stream containing O₂ and CO₂ into a cathode gas collection zone. The cathode gas collection zone can be defined by a first surface of a cathode, a second separator plate, and a cathode current collector providing support between the cathode surface and the second separator plate. The method can further include operating the molten carbonate fuel cell at an average current density of 60 mA/cm² or more and a CO₂ utilization of 60% or more to generate electricity. This can result in production of an anode exhaust containing H₂, CO, and CO₂, and a cathode exhaust containing 2.5 vol % or less CO₂. An open area of the first surface of the cathode can correspond to 40% or more of a total surface area of the cathode surface. Additionally, the molten carbonate fuel cell can include an electrolyte matrix having an interface with a second surface of the cathode and an interface with a second surface of the anode, the electrolyte matrix containing a molten alkali carbonate electrolyte.

### BRIEF DESCRIPTION OF THE FIGURES

FIG. 1 shows an example of a cathode collector structure.

FIG. 2 shows an example of a repeating pattern unit that can be used to represent the cathode collector structure shown in FIG. 1.

FIG. 3 shows an example of a repeating pattern unit that can be used to represent the cathode collector structure shown in FIG. 1 when the loop structures of the cathode collector are in contact with the cathode surface.

FIG. 4 shows an example of a cathode collector structure.

FIG. 5 shows an example of a repeating pattern unit that can be used to represent the cathode collector structure shown in FIG. 4.

FIG. 6 shows another example of the repeating pattern unit of FIG. 5.

FIG. 7 shows an SEM micrograph of the interface between the cathode and the electrolyte matrix after operation of a molten carbonate fuel cell under carbona capture conditions.

FIG. 8 shows an SEM micrograph of the interface between the anode and the electrolyte matrix after operation of a molten carbonate fuel cell under carbona capture conditions.

FIG. 9 shows an example of a molten carbonate fuel cell.

FIG. 10 shows voltage decay over time during operation under carbon capture conditions for a molten carbonate fuel cell that includes a conventional anode and has an open surface area for the cathode of 85% or more.

FIG. 11 shows voltage decay over time during operation under carbon capture conditions for a molten carbonate fuel cell that includes a sintered anode and has an open surface area for the cathode of 85% or more.

### DETAILED DESCRIPTION OF THE EMBODIMENTS

### Overview

In various aspects, systems and methods are provided for improving the operation of molten carbonate fuel cells that include cathode current collector structures that have reduced contact area between the cathode current collector and cathode in order to create increased cathode open surface area for gas transport from the gas flowing above cathode to the cathode pores. Molten carbonate fuel cells that have cathode collectors with reduced contact area with the cathode can have an increased tendency to suffer structural difficulties during operation, such as formation of gaps between electrolyte and one or both electrodes. It has been discovered that using a sintered anode in such a fuel cell can reduce or minimize the impact of such structural difficulties. The sintered anode can provide higher pore volume and/or increased structural stability in a fuel cell that includes a cathode collector that has a reduced contact area with the cathode. This can allow the sintered anode to maintain a target or desirable level of conductivity by maintaining a more stable interface between the cathode and electrolyte and/or between the anode and the electrolyte. The sintered anode may also afford a more stable pore structure, which in turn improves voltage stability over the life of the cell by the virtue of maintaining good gas transfer to the electrolyte in the electrode pores.

In conventional fuel cell designs, the contact area between the cathode collector and the cathode can correspond to 65% or more of the cathode surface. As a result, only 35% or less of the cathode surface area is available for receiving cathode input gas. When attempting to operate a molten carbonate fuel cell at high CO₂ utilization values, this limitation on the available cathode surface area can result in reduced fuel cell performance and/or degradation of fuel cell lifetime due to the insufficient transport of the reactant gases to the electrolyte present in the electrode pores.

One option for mitigating the problem of available cathode surface area is to use a cathode collector that provides an increased open surface area that is open between the gases in the flow chamber and the porous electrode. For example, a cathode collector can be used that provides an available open cathode surface area of 40% or more, or 45% or more, or 50% or more, or 55% or more, or 60% or more, such as up to 90% or possibly still higher.

While increasing the available open cathode surface area can be beneficial, it has been discovered that using a cathode current collector that provides an increased open cathode surface area can potentially cause other difficulties. For example, increasing the available open cathode surface area means that the contact area between the cathode collector and the cathode is reduced by a corresponding amount. When the contact area between the cathode collector and cathode is reduced, it means that any force exerted by the cathode collector on the cathode (such as the compression force that holds the fuel cell together) is distributed over a smaller surface area. It also increases the electrical resistance of the cell, thus reducing its efficiency, by the virtue of smaller electrically conducting cross section.

It has further been discovered that reducing the contact area between the cathode collector and the cathode can result in increased deformation of the cathode by the cathode collector. While current collector designs with smaller contact areas between the current collector and the electrode are beneficial for facilitating gas transport into the electrode pores, the smaller surface area creates larger contact pressure that in turn causes deformations in the cell and may lead to pore volume losses. It is believed that this increased deformation is further increased when a fuel cell is operated under conditions involving high CO₂ utilization, such as a CO₂ utilization of 60% or more, or 70%, or more, or 80% or more, or 90% or more, or 95% or more, such as up to 99% or possibly still higher. Without being bound by any particular theory, it is believed that this cathode deformation can result in other structural deformations or alterations within a molten carbonate fuel cell. As a result, gaps can form at the interface between the cathode and the electrolyte and/or gaps can form at the interface between the anode and the electrolyte. Electrode deformation created by the reduced contact area between the current collector and its electrode may also negatively affect the pore structure and pore volume of the electrode. There is a need for solutions that can maintain the benefits of the improved gas transport feature, while minimizing the debits caused by the increased contact pressure between the electrode and its current collector. In various aspects, this can be achieved at least in part by keeping the increased gas transport area between the electrode and its current collector while mechanically strengthening the cell and affording a more stable pore structure.

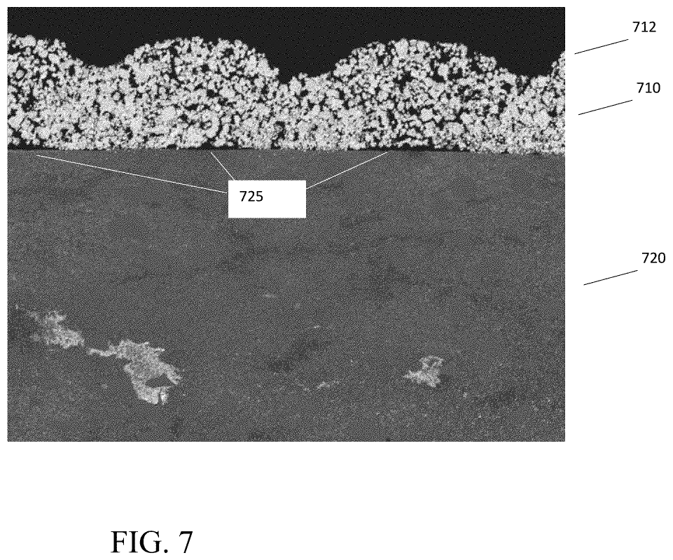

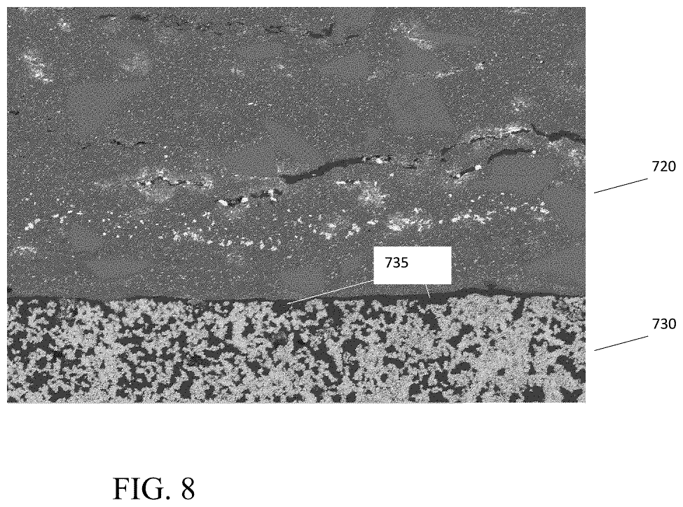

FIG. 7 and FIG. 8 illustrate the types of gaps that can form within a fuel cell. FIG. 7 shows a scanning electron microscopy (SEM) micrograph of a portion of a molten carbonate fuel cell after operation under carbon capture conditions. In FIG. 7, layer 710 corresponds to the cathode layer while layer 720 corresponds to the electrolyte matrix. It is noted that the top surface 712 of the cathode has a wavy or undulating pattern. This pattern is due to the compression of the cathode layer 720 by a cathode collector that has a reduced or minimized amount of contact area with the cathode, so that the available open cathode surface area during operation is 40% or more, or 50% or more, or 55% or more, or 60% or more, or 65% or more, or 70% or more. As shown in FIG. 7, the compression of cathode layer 710 has resulted in formation of gaps 725 at the interface between cathode layer 710 and electrolyte matrix 720. FIG. 8 shows another SEM micrograph that shows the interface between electrolyte matrix 720 and anode 730. As shown in FIG. 8, a gap 735 has also formed at the interface between electrolyte matrix 720 and anode 730. Such gaps at the interface between layers can form and/or expand during initial construction of a molten carbonate fuel cell and/or during operation.

Without being bound by any particular theory, when gaps form at an electrode/electrolyte interface, it is believed that this can cause various issues, including loss of conductivity, loss of contact between electrolyte and electrode, electrolyte loss, increased diffusion and/or mass transfer resistance for CO₂, and/or the potential for increased corrosion of the cathode collector structure. These issues can result in lower operating voltage, higher voltage decay, and/or reduction in operating lifetime for a fuel cell.

It has been discovered that the difficulties associated with operating a molten carbonate fuel cell having a reduced contact area cathode current collector at high CO₂ utilization can be mitigated by using a sintered anode in the fuel cell. A sintered anode can provide one or more benefits that reduce or minimize problems associated with fuel cell structural degradation under operation at high CO₂ utilization. In some aspects, a sintered anode can provide an increased and/or more stable pore volume. This can improve or increase entry of electrolyte and the transport of the gases into and away from the sintered anode and/or increase conductivity between the anode and the electrolyte. Additionally or alternately, the sintered anode can provide improved structural stability. It is believed that this improved structural stability can reduce or minimize formation of gaps between the electrolyte and the anode and/or otherwise reduce mechanical deformation in the fuel cell. Based in part on these improvements, a sintered anode can reduce or minimize the degradation in fuel cell performance over time when operating under high CO₂ utilization conditions.

### Sintered Anode

Conventionally, a typical anode for a molten carbonate fuel cell corresponds to an anode layer of roughly 3-10 mil (˜0.075 mm to ˜0.25 mm), often roughly 0.15 to 0.18 mm filled with binders for strength. Such an anode layer can be formed, for example, by tape casting. The binders are burned off during the fuel cell conditioning process creating the active electrode porosity. The anode can be (primarily) made of nickel alloyed with small amounts of aluminum (Al) and/or chromium (Cr) such as Ni including 3 wt % Al or Ni including 4 wt % Cr. Such an anode can have a beginning-of-life porosity of 36-40%. Because of the fragility of the tape cast anode, a nickel screen is laminated onto the tape-cast anode to act as a support. Because of some degree of imbedding of the applied nickel screen, some anode porosity is lost during cell operations.

In various aspects, in contrast to a conventional anode, a sintered anode can be used in a molten carbonate fuel cell. A sintered anode can be fabricated, for example, by dry doctoring (use of a blade to deposit catalyst thin film) of a Ni: Cr and/or NiAl powder and then sintering at an appropriate temperature. The sintering temperature can be 950° C. to 1200° C., or 1000° C. to 1200° C. The sintering can be performed in an environment that can reduce, minimize, or prevent oxidation during the sintering. For example, the sintering can be performed under an atmospheric of H₂O and H₂ gas. The sintering can be performed for a convenient sintering time period, such as 0.4 hours to 10 hours.

Forming a sintered anode can result in an anode with various properties and/or characteristics that differ from a traditional anode in a molten carbonate fuel cell. In some aspects, a sintered anode can have a beginning-of-life porosity of 45%-60%, or 45%-55%, or 48%-60%, or 48%-55%. Additionally or alternately, a sintered anode can have a thickness of 0.30 mm to 0.55 mm (12 to 22 mil), or 0.35 mm to 0.55 mm, or 0.40 mm to 0.55 mm, or 0.30 mm to 0.50 mm, or 0.35 mm to 0.50 mm, or 0.40 mm to 0.50 mm. Further additionally or alternately, because of enhanced mechanical strength, a nickel screen may not be needed to mechanically support the sintered anode. In aspects where a nickel screen is not used, porosity decrease during operation due to imbedding of the Ni screen into the anode can be avoided.

In various aspects, a sintered anode can provide a higher porosity and/or more stable porosity relative to a conventional anode. In some aspects, the higher and/or more stable porosity can enable improved electrolyte storage capacity and/or increased active electrochemical surface area. Additionally or alternately, in some aspects the improvements in electrolyte storage capacity and/or increased active electrochemical surface area can be at least partially due to the improved structural stability of a sintered anode, which is believed to be able to reduce or minimize the formation of gaps between the anode surface and the electrolyte matrix. These improvements in electrolyte storage capacity and/or increases in active electrochemical surface area (optionally including any enhancements in the structural stability of the fuel cell) can result in enhanced stability and/or longer life for the fuel cell.

### Definitions

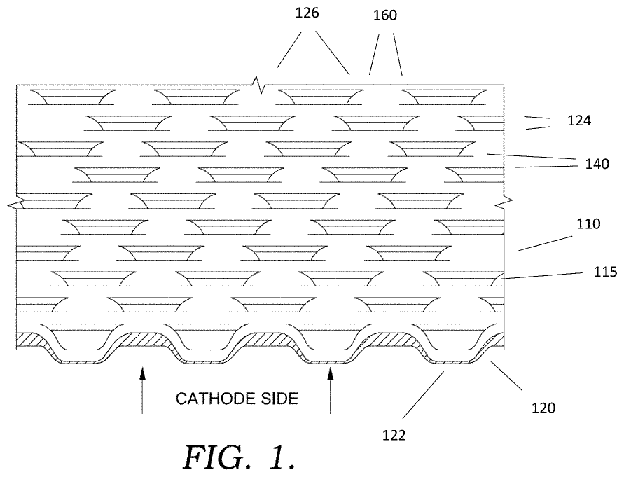

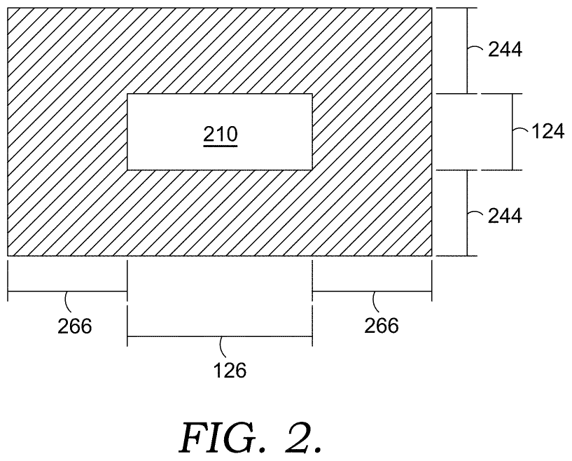

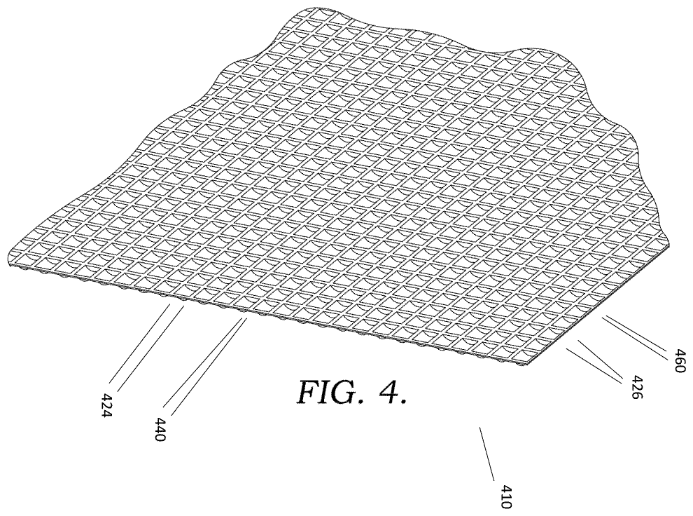

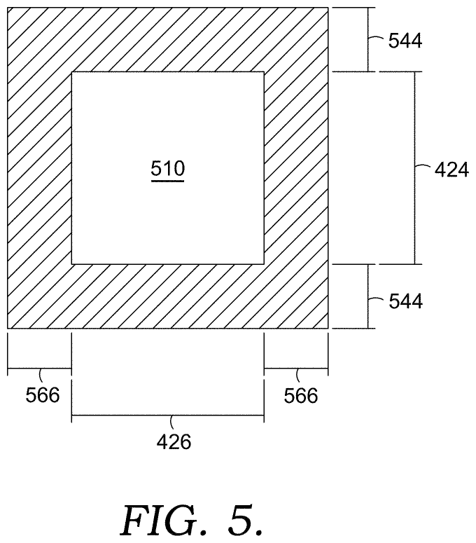

Open area and Contact Area: The open area of a cathode surface (adjacent to the cathode current collector) is defined as the percentage of the cathode surface that is not in direct contact with the cathode current collector; in other words, open to the gas phase in the cathode flow chamber. FIG. 2 and FIG. 5 show two examples of repeating units (i.e., unit cells) that can be used to represent the contact area and open area for a cathode surface that is in contact with the plate-like surface of a cathode collector. The example repeat units in FIG. 2 and FIG. 5 correspond to the repeating patterns (unit cells) that can be used to represent the structures shown in FIG. 1 and FIG. 4, respectively. In FIG. 2 and FIG. 5, the dark areas correspond to areas where the collector is in contact with the cathode surface, while the light areas correspond to areas where gas can pass between the cathode and the collector.

As an example of a calculation to determine open area, distance 126 in FIG. 2 can be set to 3.0, distance 266 can be set to 0.75, distance 124 can be set to 1.0, and distance 244 can be set to 0.5. It is noted that adding both distances 244 results in the value of distance 140 (1.5) from FIG. 1. Similarly, adding both distances 266 together results in the value of distance 160 (1.0) from FIG. 1. Based on the distances in FIG. 2, the open area 210 for the configuration shown in FIG. 2 is 33%. This can be determined, for example, by noting that the area of open area 210 is 3.0*1.0=3.0, while the area of the total repeating unit is (0.75+3.0+0.75)* (0.5+1.0+0.5)=9.0. Thus, the open area percentage is 3.0/9.0, or 33%. It is noted that the distances in FIG. 2 are normalized, and therefore are in arbitrary length units.

A similar calculation can be used to calculate the open area 510 for the repeat pattern shown in FIG. 5. In FIG. 5, distance 424 can be set to 8.0, distance 544 can be set to 1.0, distance 426 can be set to 8.0, and distance 566 can be set to 1.0. This results in an open area of 64/100, or 64%.

The contact area corresponds to the remaining portion of the cathode surface that does not correspond to open area. Thus, one option for calculating the contact area is to subtract the open area from 100%.

Average cathode gas lateral diffusion length: The average cathode gas lateral diffusion length is defined as the average lateral distance from an open area location on a cathode surface to each point on the cathode surface. For the purposes of this definition, the lateral diffusion length for any point corresponding to an open area location is defined as zero.

The average cathode gas lateral diffusion length can also be calculated for cathode surfaces having the repeating patterns shown in FIG. 2 and FIG. 5, respectively. The same normalized distances shown in FIG. 2 and FIG. 5 can be used, with the end result being multiplied by an appropriate scaling factor to represent a given configuration.

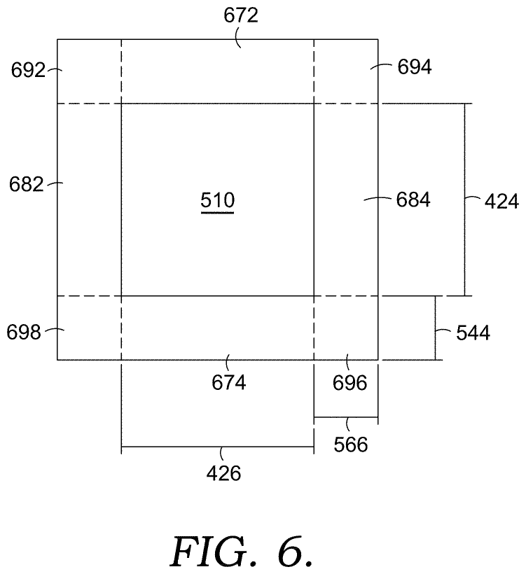

One option for determining the average cathode gas lateral diffusion length can be to directly calculate the value, based on a repeating pattern element, such as by using a commercially available software package. Additionally, relatively good approximate values can be determined in a straightforward manner. FIG. 6 shows another example of the repeating pattern element shown in FIG. 5. (Shading is not used in FIG. 6 to designate open area versus contact area.) In FIG. 6, the region around open area 510 can be divided into several pieces. For lateral areas 672 and 674, the average distance from an open area is simply half of the length of the lateral area, or 0.5. Similarly, for vertical areas 682 and 684, the average distance from an open area is half of the width of the vertical area, or 0.5. For corner areas 692, 694, 696, and 698, an upper limit for the average distance can be determined based on the maximum distance, or the distance from the open area to the top corner of the square. Half of that maximum distance is roughly 0.7, which provides a bounding upper limit for the average distances within corner areas 692, 694, 696, and 696.

The above average distances can then be used to determine the average cathode gas lateral diffusion length by multiplying the average distances by the percentage of the total area corresponding to each distance. Areas 672, 674, 682, and 684 correspond to 32% of the total area of the repeat pattern unit shown in FIG. 6. The corner areas correspond to 4% of the total area. The remaining 64% of the area corresponds to the open area 510, which by definition has a distance of zero. These values can be used to determine an upper limit for the average cathode gas lateral diffusion length of (0.64*0+0.32*0.5+0.04*0.7)=0.188. The 0.188 value can then be multiplied by a scaling factor that is representative of a real system. In this example, the scaling factor described above for FIG. 4 of 0.635 mm can be used. Multiplying 0.188 by a scaling factor of 0.635 mm results in an average cathode gas lateral diffusion length of 0.12 mm. It is noted that based on the assumptions used when calculating the average distance values for corner areas 692, 694, 696, and 698, the value of 0.12 mm represents an upper bound for the actual average cathode gas lateral diffusion length.

The calculation above can also be performed for the repeat pattern shown in FIG. 2. However, instead of determining an upper bound, the estimation for the corners can be used to provide a lower bound. Based on the values in FIG. 2, the lower bound for the average cathode gas lateral diffusion length (in normalized units, without the scaling factor) is 0.21. As described for the configuration in FIG. 1, a representative value for the scaling factor is 0.08 in, or 2.0 mm. Based on a scaling factor of 2.0 mm, the average cathode gas lateral diffusion length would be 0.42 mm.

Average contact area diffusion length: The average contact area diffusion length is defined as the average lateral distance from a contact area location on a cathode surface to each point on the cathode surface. For the purposes of this definition, the contact area diffusion length for any point corresponding to a contact area location is defined as zero. An example of this calculation will be further illustrated below.

In this discussion, a fuel cell can correspond to a single cell, with an anode and a cathode separated by an electrolyte. The anode and cathode can receive input gas flows to facilitate the respective anode and cathode reactions for transporting charge across the electrolyte and generating electricity. A fuel cell stack can comprise a plurality of cells in an integrated unit. The fuel cells in a fuel cell stack can be connected in series and/or in parallel. When an input flow is delivered to the anode or cathode of a fuel cell stack, the fuel stack can include flow channels for dividing the input flow between each of the cells in the stack and flow channels for combining the output flows from the individual cells. In this discussion, a fuel cell array can be used to refer to a plurality of fuel cells (such as a plurality of fuel cell stacks) that are arranged in series, in parallel, or in any other convenient manner (e.g., in a combination of series and parallel). A fuel cell array can include one or more stages of fuel cells and/or fuel cell stacks, where the anode/cathode output from a first stage may serve as the anode/cathode input for a second stage. It is noted that the anodes in a fuel cell array do not have to be connected in the same way as the cathodes in the array. For convenience, the input to the first anode stage of a fuel cell array may be referred to as the anode input for the array, and the input to the first cathode stage of the fuel cell array may be referred to as the cathode input to the array. Similarly, the output from the final anode/cathode stage may be referred to as the anode/cathode output from the array.

It should be understood that reference to use of a fuel cell herein typically denotes a “fuel cell stack” composed of individual fuel cells, and more generally refers to use of one or more fuel cell stacks in fluid communication. Individual fuel cell elements (plates) can typically be “stacked” together in a rectangular array called a “fuel cell stack”. This fuel cell stack can typically take a feed stream and distribute reactants among all of the individual fuel cell elements and can then collect the products from each of these elements. When viewed as a unit, the fuel cell stack in operation can be taken as a whole even though composed of many (often tens or hundreds) of individual fuel cell elements. These individual fuel cell elements can typically have similar voltages (as the reactant and product concentrations are similar), and the total power output can result from the summation of all of the electrical currents in all of the cell elements, when the elements are electrically connected in series. Stacks can also be arranged in a series arrangement to produce high voltages. A parallel arrangement can boost the current. If a sufficiently large volume fuel cell stack is available to process a given exhaust flow, the systems and methods described herein can be used with a single molten carbonate fuel cell stack. In other aspects of the invention, a plurality of fuel cell stacks may be desirable or needed for a variety of reasons.

For the purposes of this invention, unless otherwise specified, the term “fuel cell” should be understood to also refer to and/or is defined as including a reference to a fuel cell stack composed of set of one or more individual fuel cell elements for which there is a single input and output, as that is the manner in which fuel cells are typically employed in practice. Similarly, the term fuel cells (plural), unless otherwise specified, should be understood to also refer to and/or is defined as including a plurality of separate fuel cell stacks. In other words, all references within this document, unless specifically noted, can refer interchangeably to the operation of a fuel cell stack as a “fuel cell”. For example, the volume of exhaust generated by a commercial scale combustion generator may be too large for processing by a fuel cell (i.e., a single stack) of conventional size. In order to process the full exhaust, a plurality of fuel cells (i.e., two or more separate fuel cells or fuel cell stacks) can be arranged in parallel, so that each fuel cell can process (roughly) an equal portion of the combustion exhaust. Although multiple fuel cells can be used, each fuel cell can typically be operated in a generally similar manner, given its (roughly) equal portion of the combustion exhaust.

### Molten Carbonate Fuel Cell Structure

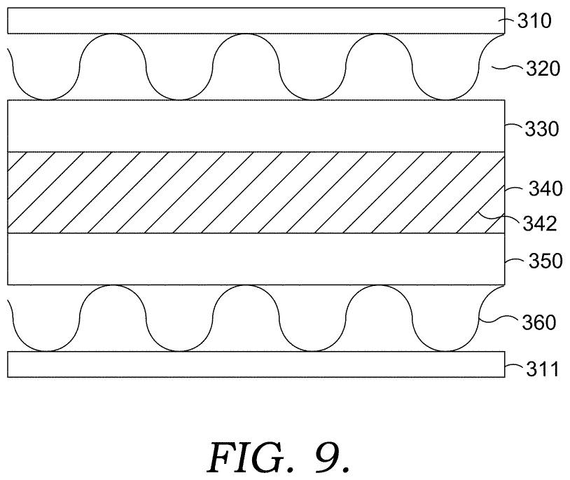

FIG. 9 shows a general example of a portion of a molten carbonate fuel cell stack. The portion of the stack shown in FIG. 9 corresponds to a fuel cell 301. In order to isolate the fuel cell from adjacent fuel cells in the stack and/or other elements in the stack, the fuel cell includes separator plates 310 and 311. In FIG. 9, the fuel cell 301 includes an anode 330 and a cathode 350 that are separated by an electrolyte matrix 340 that contains an electrolyte 342.

In some aspects, cathode 350 can correspond to a dual-layer (or multi-layer) cathode. Anode collector 320 provides electrical contact between anode 330 and the other anodes in the stack, while cathode collector 360 provides similar electrical contact between cathode 350 and the other cathodes in the fuel cell stack. Additionally anode collector 320 allows for introduction and exhaust of gases from anode 330, while cathode collector 360 allows for introduction and exhaust of gases from cathode 350.

During operation, CO₂ is passed into the cathode collector 360 along with O₂. The CO₂ and O₂ diffuse into the porous cathode 350 and travel to a cathode interface region near the boundary of cathode 350 and electrolyte matrix 340. In the cathode interface region, a portion of electrolyte 342 can be present in the pores of cathode 350. The CO₂ and O₂ can be converted near/in the cathode interface region to carbonate ion (CO₃²⁻), which can then be transported across electrolyte 342 (and therefore across electrolyte matrix 340) to facilitate generation of electrical current. In aspects where alternative ion transport is occurring, a portion of the O₂ can be converted to an alternative ion, such as a hydroxide ion or a peroxide ion, for transport in electrolyte 342. After transport across the electrolyte 342, the carbonate ion (or alternative ion) can reach an anode interface region near the boundary of electrolyte matrix 340 and anode 330. The carbonate ion can be converted back to CO₂ and H₂O in the presence of H₂, releasing electrons that are used to form the current generated by the fuel cell. The H₂ and/or a hydrocarbon suitable for forming H₂ are introduced into anode 330 via anode collector 320.

The flow direction within the anode of a molten carbonate fuel cell can have any convenient orientation relative to the flow direction within a cathode. One option can be to use a cross-flow configuration, so that the flow direction within the anode is roughly at a 90° angle relative to the flow direction within the cathode. Another option can be to use a co-current flow configuration, so that the flow direction within the anode is roughly aligned with the flow direction in the cathode. Yet another option can be to use a counter-current flow configuration, so that the axis of flow in the anode and cathode is roughly aligned but in opposite directions.

In some aspects, any convenient type of electrolyte suitable for operation of a molten carbonate fuel cell can be used. Many conventional MCFCs use a eutectic carbonate mixture as the carbonate electrolyte, such as a eutectic mixture of 62 mol % lithium carbonate and 38 mol % potassium carbonate (62% Li₂CO₃/38% K₂CO₃) or a eutectic mixture of 52 mol % lithium carbonate and 48 mol % sodium carbonate (52% Li₂CO₃/48% Na₂CO₃). Other eutectic mixtures are also available, such as a eutectic mixture of 40 mol % lithium carbonate and 60 mol % potassium carbonate (40% Li₂CO₃/60% K₂CO₃). While eutectic mixtures of carbonate can be convenient as an electrolyte for various reasons, non-eutectic mixtures of carbonates can also be suitable. Generally, such non-eutectic mixtures can include various combinations of lithium carbonate, sodium carbonate, and/or potassium carbonate. Optionally, lesser amounts of other metal carbonates can be included in the electrolyte as additives, such as other alkali carbonates (rubidium carbonate, cesium carbonate), or other types of metal carbonates such as barium carbonate, bismuth carbonate, lanthanum carbonate, or tantalum carbonate.

The total electrochemical potential difference for the reactions in a molten carbonate fuel cell is ˜1.04 V. Due to practical considerations, an MCFC is typically operated to generate current at a voltage near 0.7 V or about 0.8 V. This corresponds to a combined voltage drop across the cathode, electrolyte, and anode of roughly 0.34 V. In order to maintain stable operation, the combined voltage drop across the cathode, electrolyte, and anode can be less than ˜0.5 V, so that the resulting current generated by the fuel cell is at a voltage of 0.55 V or more, or 0.6 V or more.

A suitable temperature for operation of an MCFC can be between 450° C. and 725° C., or 450° C. to 700° C., or 500° C. to 700° C., or 550° C. to 700° C. e.g., with a cathode and/or anode inlet temperature of 500° C. and an outlet temperature of 575° C., or with a cathode and/or anode inlet temperature of 550° C. and an outlet temperature of 625° C., or with a cathode and/or anode inlet temperature of 575° C. and an outlet temperature of 650° C., or with a cathode and/or anode inlet temperature of 600° C. and an outlet temperature of 675° C., or with a cathode and/or anode inlet temperature of 625° C. and an outlet temperature of 700° C., or with a cathode and/or anode inlet temperature of 650° C. and an outlet temperature of 725° C. Additionally or alternately, the cathode and/or anode inlet temperature can range from 500° C. to 650° C., or from 550° C. to 650° C. Further additionally or alternately, the cathode and/or anode outlet temperature can range from 575° C. to 725° C., or from 600° C. to 700° C.

An MCFC can be operated to produce electric current. In various aspects, any convenient current density can be generated. For example, the current density during fuel cell operation can range from 60 mA/cm² to 250 mA/cm², or 100 mA/cm² to 250 mA/cm², or 100 mA/cm² to 140 mA/cm², or 100 mA/cm² to 160 mA/cm², or 100 mA/cm² to 180 mA/cm², or 100 mA/cm² to 200 mA/cm².

### Cathode Collector Configurations with Increased Open Area

A typical value for the open area on the cathode surface in a conventional molten carbonate fuel is roughly 33%. FIG. 1 shows an example of a cathode collector configuration that would result in an open area of 33% if used in a conventional configuration. In FIG. 1, surface 110 of the collector corresponds to a plate-like surface that includes a regular pattern of openings 115. The openings 115 in surface 110 were formed by punching the surface to form loop structures 120 that extend below the plane of surface 110. In a conventional configuration, surface 110 would be placed in contact with a cathode surface (such as a surface of cathode 350 in FIG. 9), while loop structures 120 would extend upward to support a bipolar plate, separator plate, or other plate structure that is used to define the volume for receiving a cathode input gas. The plate structure would contact loop structures 120 at the bottom edge 122 of the loop structures. In FIG. 1, the spacing 140 between openings 120 is roughly the same distance as the length 124 of the openings 120. In FIG. 1, the spacing 160 between the openings is roughly half of the width 126 of the openings 120. As explained below, based on these relative distance relationships, this type of repeating pattern results in an open area of roughly 33%. It is noted that a typical value for length 124 can be roughly 2.0 mm, while a typical value for width 126 can be roughly 6.0 mm.

Conventionally, a cathode collector structure such as the structure shown in FIG. 1 would be oriented so that plate-like surface 110 is in contact with the cathode surface, such as cathode 350 in FIG. 9. In various aspects, instead of using a conventional configuration, a cathode collector (such as the structures shown in FIG. 1 or FIG. 4) can be oriented so that the bottoms edges 122 of the loop structures 120 are in contact with the cathode surface, while plate-like surface 110 is in contact with the separator plate. This can substantially increase the open area on the cathode surface and/or reduce the average cathode gas lateral diffusion length. However, due to the more limited nature of the electrical contact between the cathode surface and the collector, the average contact area diffusion length can be increased. Additionally, the reduced contact area between the cathode collector structure and the cathode can increase the amount of deformation of the cathode that occurs when operating under high CO₂ utilization conditions.

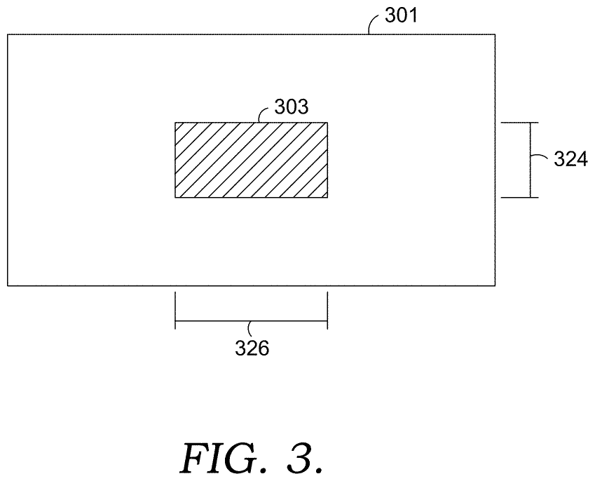

In a configuration where the bottom edges 122 of loop structures 120 are in contact with cathode surface, the repeat pattern for the contact area of the cathode surface with the collector can be represented by FIG. 3. FIG. 3 has the same repeat cell size as the pattern shown in FIG. 2, as represented by square 301. However, most of the repeat pattern corresponds to open area. A central portion 303 of square 301 is shown in dark color, indicating the contact of the bottom edge of a loop structure with the surface of the collector.

In FIG. 3, the height 324 of the central portion 303 is 1.0, or the same as the height 124 of the open area 120 in FIG. 2. The width 326 of the central portion 303 is 1.5, or half of the width 126 of the open area 120 in FIG. 2. The total length and width of unit cell 301 are the same as the pattern shown in FIG. 2. This results in a contact area of 1.5/9.0, or roughly 16%.

Based on the pattern shown in FIG. 3, the average carbonate lateral diffusion length can be determined in a manner similar to the calculation of average cathode gas lateral diffusion length illustrated by FIG. 6. It is noted that the contact area (corresponding to area 303) is defined to have a diffusion length of zero. Based on the pattern shown in FIG. 3, a lower bound for the average contact area diffusion length corresponds to 0.54 in arbitrary units. When multiplied by a scaling factor of 2.0 mm, this results in a lower bound for the average contact area diffusion length of 1.08 mm.

FIG. 4 shows an example of a different type of cathode collector configuration. In FIG. 4, the distance relationships between the openings and the spacing between the openings is changed. If the configuration in FIG. 4 is deployed with surface 410 in contact with a cathode surface, the resulting open area would be roughly 64%. This is based on the relationships of having length 424 and width 426 being roughly the same (i.e., roughly square openings), with spacing 440 and spacing 460 being roughly 0.125 times (i.e., roughly one-eighth) the length and width, respectively. An example of a suitable value for length 424 and width 426 is roughly 5.1 mm, while a suitable value for spacing 440 and 460 is roughly 0.635 mm. It is noted that the rectangular pattern in FIG. 1 and the square pattern in FIG. 4 represent convenient patterns for illustration, and that any other convenient type of pattern and/or irregular arrangement of openings could also be used.

In some aspects, increased open area and/or reduced cathode gas diffusion length can be provided by using a cathode collector similar to FIG. 4, where a configuration with surface 410 in contact with the cathode surface results in an open area of 45% or more. In other aspects, increased open area and/or reduced cathode gas diffusion length can be provided by using a cathode configuration where the loop structures of the collector are in proximity to the cathode surface and the plate-like structure (if any) is in contact with the separator plate. In such a configuration, the open area of the cathode surface can be substantially increased, and can typically be greater than 50%. To illustrate, a calculation can be performed based on using the cathode collector in FIG. 4 in a configuration where the bottom edges of the loop structures are in contact with the cathode surface. For purposes of the calculation, assumptions can be made that the width of the contact area is half of the open area in FIG. 5 or FIG. 6, while the length of the contact area is the same as the open area in FIG. 5 or FIG. 6. Based on these values, using the collector in FIG. 4 can result in a contact area of 32% and an upper bound for the average contact area diffusion length of 0.47 (normalized). When multiplied by the scaling factor used for FIG. 4 of 1.27 mm, the resulting average contact area diffusion length is roughly 0.6 mm.

More generally, a cathode collector can be characterized based on the percentage of the cathode surface that CO₂ can effectively reach without requiring substantial diffusion through the cathode. One type of characterization can be based on the open area of the cathode. This corresponds to the portion of the cathode surface that is not in contact with the cathode collector. For example, as defined herein, the open area of the cathode surface can be 40% or more, or 45% or more, or 50% or more, or 55% or more, or 60% or more, such as up to substantially all of the cathode surface corresponding to open area (i.e., up to roughly 99%). This is in contrast to conventional cathode collector structures, which can have open areas of the cathode surface of 40% or less, or 35% or less. Additionally or alternately, the characterization can be based on an average cathode gas lateral diffusion length to reach the cathode surface. For example, as defined herein, the average cathode gas lateral diffusion length can be 0.4 mm or less, or 0.3 mm or less, or 0.2 mm or less. Additionally or alternately, one option for increasing the open area can be to reduce or minimize the amount of contiguous closed or blocked area at the cathode surface. This can be achieved, for example, by using a cathode collector structure where the distance from any point on the cathode surface to an open area location is less than 1 mm in any direction.

Additionally or alternately, in some aspects, the cathode collector can be characterized based on the contact area between the cathode and the cathode collector. Conventionally, typical cathode collector structures can interact with the cathode surface based on having a plate-like structure that has openings to allow the cathode input gas to have access to the cathode surface. In a conventional configuration, the plate-like structure is in contact with the cathode surface. Optionally, the openings in the plate-like structure can be formed by forming loop structures in the plate, so that the loops protrude upward from the plate-like surface. The loop structures can then provide both support and electrical contact with the separator plate that defines the boundary of the fuel cell. For such a conventional configuration, providing sufficient electrical contact is of low concern. However, for cathode collector structures without a plate-like structure in contact with the cathode surface, the formation of carbonate ions may be limited due to lack of proximity to a conductive surface that can provide the needed electrons. One type of characterization can be based on the percentage of contact area between the cathode and the cathode collector. As defined herein, the percentage of contact area between the cathode surface can the cathode collector can be determined based on the open area, with the contact area being calculated by subtracting the open area from 100%. In some aspects, the contact area can be 10% or more, or 15% or more, or 18% or more, such as up to 65% or possibly still higher. Additionally or alternately, the characterization can be based on an average lateral contact length, corresponding to an average distance between a point on the cathode surface and a point of contact between the cathode collector and the cathode surface. For example, as defined herein, the average contact area diffusion length can be 1.0 mm or less, or 0.9 mm or less, or 0.7 mm or less.

Optionally, when a cathode collector is used with an open area greater than 70% and/or an increased average contact area diffusion length, an additional structure can be included to reduce the average contact area diffusion length. For example, an open mesh screen with small mesh size (roughly 1.0 mm or less average cell width and/or length) can be placed between the cathode surface and the bottom edges of loop structures and/or other contact points for contact between a cathode collector structure and a cathode. Such a screen can be supported by the cathode surface and/or loop structures, so the screen does not need to provide structural support. As a result, the percentage of the surface that is covered by the mesh structural material can be relatively low. Additionally, by using a small mesh size, the average contact area diffusion length can be greatly reduced. For example, with a mesh size of 1.0 mm or less, the corresponding average contact area diffusion length can be reduced to 0.3 mm or less.

### Anode Inputs and Outputs

Suitable conditions for the anode can include providing the anode with H₂, a reformable fuel, or a combination thereof; and operating with any convenient fuel utilization that generates a desired current density, including fuel utilizations ranging from 20% to 80%. In some aspects this can correspond to a traditional fuel utilization amount, such as a fuel utilization of 60% or more, or 70% or more, such as up to 85% or possibly still higher. In other aspects, this can correspond to a fuel utilization selected to provide an anode output stream with an elevated content of H₂ and/or an elevated combined content of H₂ and CO (i.e., syngas), such as a fuel utilization of 55% or less, or 50% or less, or 40% or less, such as down to 20% or possibly still lower. The H₂ content in the anode output stream and/or the combined content of H₂ and CO in the anode output stream can be sufficient to allow generation of a desired current density. In some aspects, the H₂ content in the anode output stream can be 3.0 vol % or more, or 5.0 vol % or more, or 8.0 vol % or more, such as up to 15 vol % or possibly still higher. Additionally or alternately, the combined amount of H₂ and CO in the anode output stream can be 4.0 vol % or more, or 6.0 vol % or more, or 10 vol % or more, such as up to 20 vol % or possibly still higher. Optionally, when the fuel cell is operated with low fuel utilization, the H₂ content in the anode output stream can be in a higher range, such as an H₂ content of 10 vol % to 25 vol %. In such aspects, the syngas content of the anode output stream can be correspondingly higher, such as a combined H₂ and CO content of 15 vol % to 35 vol %. Depending on the aspect, the anode can be operated to increase the amount of electrical energy generated, to increase the amount of chemical energy generated, (i.e., H₂ generated by reforming that is available in the anode output stream), or operated using any other convenient strategy.

In various aspects, the anode input stream for a MCFC can include hydrogen, a hydrocarbon such as methane, a hydrocarbonaceous or hydrocarbon-like compound that may contain heteroatoms different from C and H, or a combination thereof The source of the hydrogen/hydrocarbon/hydrocarbon-like compounds can be referred to as a fuel source. In some aspects, most of the methane (or other hydrocarbon, hydrocarbonaceous, or hydrocarbon-like compound) fed to the anode can typically be fresh methane. In this description, a fresh fuel such as fresh methane refers to a fuel that is not recycled from another fuel cell process. For example, methane recycled from the anode outlet stream back to the anode inlet may not be considered “fresh” methane, and can instead be described as reclaimed methane.

The fuel source used can be shared with other components, such as a turbine that uses a portion of the fuel source to provide a CO₂-containing stream for the cathode input. The fuel source input can include water in a proportion to the fuel appropriate for reforming the hydrocarbon (or hydrocarbon-like) compound in the reforming section that generates hydrogen. For example, if methane is the fuel input for reforming to generate Hz, the molar ratio of water to fuel can be from about one to one to about ten to one, such as at least about two to one. A ratio of four to one or greater is typical for external reforming, but lower values can be typical for internal reforming. To the degree that H₂ is a portion of the fuel source, in some optional aspects no additional water may be needed in the fuel, as the oxidation of H₂ at the anode can tend to produce H₂O that can be used for reforming the fuel. The fuel source can also optionally contain components incidental to the fuel source (e.g., a natural gas feed can contain some content of CO₂ as an additional component). For example, a natural gas feed can contain CO₂, N₂, and/or other inert (noble) gases as additional components. Optionally, in some aspects the fuel source may also contain CO, such as CO from a recycled portion of the anode exhaust. An additional or alternate potential source for CO in the fuel into a fuel cell assembly can be CO generated by steam reforming of a hydrocarbon fuel performed on the fuel prior to entering the fuel cell assembly.

More generally, a variety of types of fuel streams may be suitable for use as an anode input stream for the anode of a molten carbonate fuel cell. Some fuel streams can correspond to streams containing hydrocarbons and/or hydrocarbon-like compounds that may also include heteroatoms different from C and H. In this discussion, unless otherwise specified, a reference to a fuel stream containing hydrocarbons for an MCFC anode is defined to include fuel streams containing such hydrocarbon-like compounds. Examples of hydrocarbon (including hydrocarbon-like) fuel streams include natural gas, streams containing C1-C4 carbon compounds (such as methane or ethane), and streams containing heavier C5+ hydrocarbons (including hydrocarbon-like compounds), as well as combinations thereof. Still other additional or alternate examples of potential fuel streams for use in an anode input can include biogas-type streams, such as methane produced from natural (biological) decomposition of organic material.

In some aspects, a molten carbonate fuel cell can be used to process an input fuel stream, such as a natural gas and/or hydrocarbon stream, with a low energy content due to the presence of diluent compounds. For example, some sources of methane and/or natural gas are sources that can include substantial amounts of either CO₂ or other inert molecules, such as nitrogen, argon, or helium. Due to the presence of elevated amounts of CO₂ and/or inerts, the energy content of a fuel stream based on the source can be reduced. Using a low energy content fuel for a combustion reaction (such as for powering a combustion-powered turbine) can pose difficulties. However, a molten carbonate fuel cell can generate power based on a low energy content fuel source with a reduced or minimal impact on the efficiency of the fuel cell. The presence of additional gas volume can require additional heat for raising the temperature of the fuel to the temperature for reforming and/or the anode reaction. Additionally, due to the equilibrium nature of the water gas shift reaction within a fuel cell anode, the presence of additional CO₂ can have an impact on the relative amounts of H₂ and CO present in the anode output. However, the inert compounds otherwise can have only a minimal direct impact on the reforming and anode reactions. The amount of CO₂ and/or inert compounds in a fuel stream for a molten carbonate fuel cell, when present, can be 1 vol % or more, or 2 vol % or more, or 5 vol % or more, or 10 vol % or more, or 15 vol % or more, or 20 vol % or more, or 25 vol % or more, or 30 vol % or more, or 35 vol % or more, or 40 vol % or more, or 45 vol % or more, or 50 vol % or more, or 75 vol % or more. Additionally or alternately, the amount of CO₂ and/or inert compounds in a fuel stream for a molten carbonate fuel cell can be 90 vol % or less, such as 75 vol % or less, or 60 vol % or less, or 50 vol % or less, or 40 vol % or less, or 35 vol % or less.

Yet other examples of potential sources for an anode input stream can correspond to refinery and/or other industrial process output streams. For example, coking is a common process in many refineries for converting heavier compounds to lower boiling ranges. Coking typically produces an off-gas containing a variety of compounds that are gases at room temperature, including CO and various C₁-C₄ hydrocarbons. This off-gas can be used as at least a portion of an anode input stream. Other refinery off-gas streams can additionally or alternately be suitable for inclusion in an anode input stream, such as light ends (C₁-C₄) generated during cracking or other refinery processes. Still other suitable refinery streams can additionally or alternately include refinery streams containing CO or CO₂ that also contain H₂ and/or reformable fuel compounds.

Still other potential sources for an anode input can additionally or alternately include streams with increased water content. For example, an ethanol output stream from an ethanol plant (or another type of fermentation process) can include a substantial portion of H₂O prior to final distillation. Such H₂O can typically cause only minimal impact on the operation of a fuel cell. Thus, a fermentation mixture of alcohol (or other fermentation product) and water can be used as at least a portion of an anode input stream.

Biogas, or digester gas, is another additional or alternate potential source for an anode input. Biogas may primarily comprise methane and CO₂ and is typically produced by the breakdown or digestion of organic matter. Anaerobic bacteria may be used to digest the organic matter and produce the biogas. Impurities, such as sulfur-containing compounds, may be removed from the biogas prior to use as an anode input.

The output stream from an MCFC anode can include H₂O, CO₂, CO, and H₂. Optionally, the anode output stream could also have unreacted fuel (such as H₂ or CH₄) or inert compounds in the feed as additional output components. Instead of using this output stream as a fuel source to provide heat for a reforming reaction or as a combustion fuel for heating the cell, one or more separations can be performed on the anode output stream to separate the CO₂ from the components with potential value as inputs to another process, such as H₂ or CO. The H₂ and/or CO can be used as a syngas for chemical synthesis, as a source of hydrogen for chemical reaction, and/or as a fuel with reduced greenhouse gas emissions.

### Cathode Inputs and Outputs

In some aspects, the CO₂ concentration in the cathode input flow can be 3.0 vol % or more, or 4.0 vol % or more, or 5.0 vol % or more, or 8.0 vol % or more, such as up to 25 vol % or possibly still higher. Generally, a molten carbonate fuel cell can be operated at any convenient CO₂ utilization value between 20% and 95%. This can result in CO₂ concentrations in the cathode output flow of 2.0 vol % to 10 vol %. In some aspects, when a fuel cell is operated for carbon capture, the fuel cell can be operated at a CO₂ utilization of 60% or more, or 70% or more, or 80% or more, or 88% or more, or 92% or more, such as up to 95% or possibly still higher. For example, the CO₂ utilization can be 60% to 95%, or 65% to 95%, or 70% to 95%, or 75% to 95%, or 80% to 95%, or 60% to 90%, or 65% to 90%, or 70% to 90%, or 75% to 90%, or 80% to 90%. In such aspects, the CO₂ content in the cathode output flow can be 2.5 vol % or less, or 2.0 vol % or less, or 1.5 vol % or less, or 1.0 vol % or less, such as down to 0.4 vol % or possibly still lower.

One example of a suitable CO₂-containing stream for use as a cathode input flow can be an output or exhaust flow from a combustion source. Examples of combustion sources include, but are not limited to, sources based on combustion of natural gas, combustion of coal, and/or combustion of other hydrocarbon-type fuels (including biologically derived fuels). Additional or alternate sources can include other types of boilers, fired heaters, furnaces, and/or other types of devices that burn carbon-containing fuels in order to heat another substance (such as water or air).

Other potential sources for a cathode input stream can additionally or alternately include sources of bio-produced CO₂. This can include, for example, CO₂ generated during processing of bio-derived compounds, such as CO₂ generated during ethanol production. An additional or alternate example can include CO₂ generated by combustion of a bio-produced fuel, such as combustion of lignocellulose. Still other additional or alternate potential CO₂ sources can correspond to output or exhaust streams from various industrial processes, such as CO₂-containing streams generated by plants for manufacture of steel, cement, and/or paper.

Yet another additional or alternate potential source of CO₂ can be CO₂-containing streams from a fuel cell. The CO₂-containing stream from a fuel cell can correspond to a cathode output stream from a different fuel cell, an anode output stream from a different fuel cell, a recycle stream from the cathode output to the cathode input of a fuel cell, and/or a recycle stream from an anode output to a cathode input of a fuel cell. For example, an MCFC operated in standalone mode under conventional conditions can generate a cathode exhaust with a CO₂ concentration of at least about 5 vol %. Such a CO₂-containing cathode exhaust could be used as a cathode input for an MCFC operated according to an aspect of the invention. More generally, other types of fuel cells that generate a CO₂ output from the cathode exhaust can additionally or alternately be used, as well as other types of CO₂-containing streams not generated by a “combustion” reaction and/or by a combustion-powered generator. Optionally but preferably, a CO₂-containing stream from another fuel cell can be from another molten carbonate fuel cell. For example, for molten carbonate fuel cells connected in series with respect to the cathodes, the output from the cathode for a first molten carbonate fuel cell can be used as the input to the cathode for a second molten carbonate fuel cell.

In addition to CO₂, a cathode input stream can include O₂ to provide the components necessary for the cathode reaction. Some cathode input streams can be based on having air as a component. For example, a combustion exhaust stream can be formed by combusting a hydrocarbon fuel in the presence of air. Such a combustion exhaust stream, or another type of cathode input stream having an oxygen content based on inclusion of air, can have an oxygen content of 20 vol % or less, such as 15 vol % or less, or 10 vol % or less. Additionally or alternately, the oxygen content of the cathode input stream can be 4 vol % or more, or 6 vol % or more, or 8 vol % or more. More generally, a cathode input stream can have a suitable content of oxygen for performing the cathode reaction. In some aspects, this can correspond to an oxygen content of 5 vol % to 15 vol %, such as from 7 vol % to 9 vol %. For many types of cathode input streams, the combined amount of CO₂ and O₂ can correspond to less than 21 vol % of the input stream, such as less than 15 vol % of the stream or less than 10 vol % of the stream. An air stream containing oxygen can be combined with a CO₂ source that has low oxygen content. For example, the exhaust stream generated by burning coal may include a low oxygen content that can be mixed with air to form a cathode inlet stream.

In addition to CO₂ and O₂, a cathode input stream can also be composed of inert/non-reactive species such as N₂, H₂O, and other typical oxidant (air) components. For example, for a cathode input derived from an exhaust from a combustion reaction, if air is used as part of the oxidant source for the combustion reaction, the exhaust gas can include typical components of air such as N₂, H₂O, and other compounds in minor amounts that are present in air. Depending on the nature of the fuel source for the combustion reaction, additional species present after combustion based on the fuel source may include one or more of H₂O, oxides of nitrogen (NOx) and/or sulfur (SOx), and other compounds either present in the fuel and/or that are partial or complete combustion products of compounds present in the fuel, such as CO. These species may be present in amounts that do not poison the cathode catalyst surfaces though they may reduce the overall cathode activity. Such reductions in performance may be acceptable, or species that interact with the cathode catalyst may be reduced to acceptable levels by known pollutant removal technologies.

The amount of O₂ present in a cathode input stream (such as an input cathode stream based on a combustion exhaust) can advantageously be sufficient to provide the oxygen needed for the cathode reaction in the fuel cell. Thus, the volume percentage of O₂ can advantageously be at least 0.5 times the amount of CO₂ in the exhaust. Optionally, as necessary, additional air can be added to the cathode input to provide sufficient oxidant for the cathode reaction. When some form of air is used as the oxidant, the amount of N₂ in the cathode exhaust can be 78 vol % or more, or 88 vol %, and/or 95 vol % or less. In some aspects, the cathode input stream can additionally or alternately contain compounds that are generally viewed as contaminants, such as H₂S or NH₃. In other aspects, the cathode input stream can be cleaned to reduce or minimize the content of such contaminants.

### EXAMPLES

Several bench-scale, single cells (250 cm² active area for cathode and anode) were tested to determine the performance and stability of advanced sintered anode. The anode in each cell assembly corresponded to either a) a porous Ni—Al and/or Ni—Cr anode (in preference Ni—Cr or a mixture of Ni—Al—Cr made by tape casting process for baseline NGCC cells) or b) a sintered anode made of 100% NiCr with a thickness of 0.35 mm to 0.475 mm. Each cell included a porous in-situ oxidized and lithiated NiO cathode. The anode and cathode were separated by a porous ceramic matrix (LiAlO₂). In each cell, the cathode was filled with an appropriate amount of Li/K or Li/Na electrolyte and an appropriate amount of Li/Na or Li/k electrolyte was also stored in cathode current collector to achieve the electrolyte balance required for a target operating lifetime.

The various fuel cells were tested using an anode gas having a composition of 72.8% H₂—18.2% CO₂—9% H₂O. The composition of the cathode gas was 4.5% CO₂—10.98% O₂—74.5% N₂—10% H₂O. All tests were conducted at a current density of 150 mA/cm², 65% fuel utilization and 90% CO₂ utilization (UCO₂: 90%). The fuel cells were operated in a counter-current flow configuration at a temperature of 650° C.

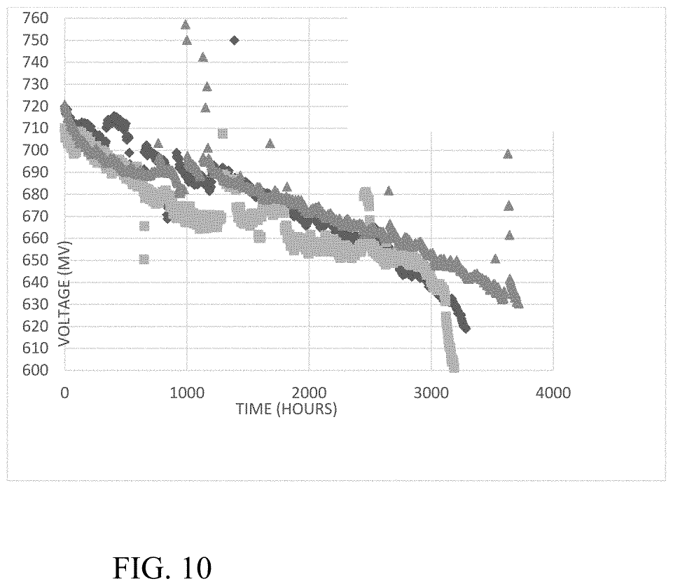

The fuel cells included a stainless steel cathode collector structure that provided a cathode open surface area of 85% or more. Voltage stability was monitored with time to evaluate the performance and life stability of using a sintered anode versus a conventional anode. For purposes of demonstrating the benefit of a sintered anode, a cathode collector structure that provided a relatively high cathode open surface area was selected. It is believed that the voltage decay trends shown in FIG. 10 are qualitatively representative of voltage decay trends for any cathode collector structure having an open cathode surface area of 45% or more. Using a fuel cell with a higher cathode open surface area allowed the differences in voltage decay between a conventional anode and a sintered anode to be more pronounced at shorter time scales.

FIG. 10 shows results from operating several fuel cells that included a conventional anode. As shown in FIG. 10, when used under carbon capture conditions (150 mA/cm², 650° C., 90% CO₂ utilization, and 65% fuel utilization), the voltage decay was at least 15 mV/1000 hours. Even if the slope of the voltage decay line was reduced by a factor of two, this would still correspond to a substantial loss in operating voltage over time. In addition, exponential voltage decay frequently occurred at around the 3000-4000 hour mark. This is believed to potentially be related to component delamination at the anode-matrix and/or cathode-matrix interfaces. It is noted that having exponential voltage decay at roughly 3000-4000 hours represents roughly half a year of operation. While the operating time prior to exponential voltage decay may be longer for fuel cells with cathode open surface areas closer to 50%, this still would represent an undesirably short operating lifetime for a commercial fuel cell installation.

Based on various additional runs using a conventional anode, a “baseline average” of voltage decay for a conventional fuel cell was developed, including error bars to corresponding to the 25% and 75% quintile. Since single cell tests are accelerated in terms of aging/voltage decay and resistance increase, the performance benefit may not be as pronounced as in the case of full-size stacks. Besides the improved electrolyte storage and better gas diffusion, sintered anode would improve the current distribution, the thermal profile and reduce the delta T in full size area stacks, enabling reduced electrolyte loss, lower voltage decay and extended cell/stack life.

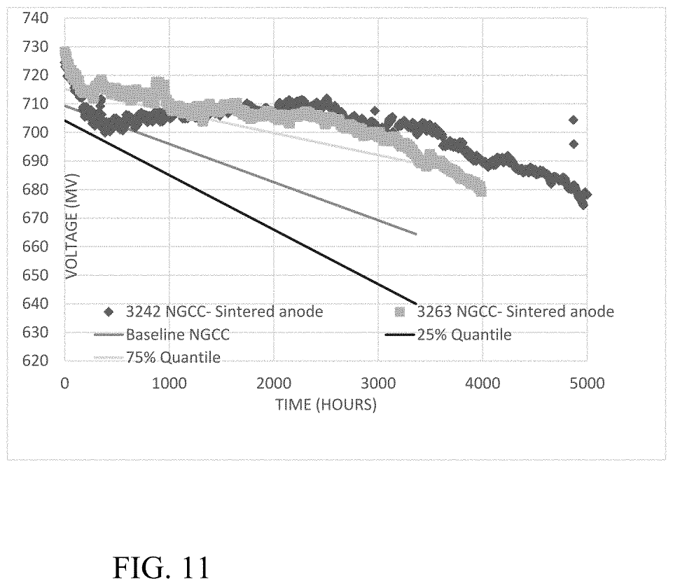

The baseline average and error bars are shown in FIG. 11, along with voltage decay curves for two fuel cells that included a sintered anode. It is noted that the baseline average shown in FIG. 11 represents substantially less voltage decay than the voltage decay shown in FIG. 10. As shown in FIG. 11, even though the baseline average represents a relatively favorable average of fuel cell operation when using a conventional anode, the sintered anode cells still exhibited substantially higher performance and improved stability. The voltage benefit is at least 30 mV at 3000 hours of operations due to the significantly reduced voltage decay rate (<8 mV/1000 hours compared to 12-15 mV/1000 hours for the baseline average). In addition, the end of cell life associated by the sharp drop off in cell voltage frequently seen at 3000-3500 hours when using a conventional anode is avoided when using a sintered anode. Without being bound by any particular theory, it is believed that this improvement stems mainly from decreased gas-diffusion resistance due to stable large pores and higher porosity of the sintered anodes.

### Additional Embodiments

Embodiment 1. A molten carbonate fuel cell, comprising: a first separator plate; a cathode current collector; a cathode, the cathode current collector providing support between the first separator plate and a first surface of the cathode, an open area of the first surface of the cathode comprising 40% or more of the total surface area of the first surface of the cathode; a second separator plate; an anode current collector; an anode comprising a thickness of 0.30 mm or more and beginning-of-life porosity of 45% or more, the anode collector providing support between the second separator plate and a first surface of the anode; and an electrolyte matrix having an interface with a second surface of the cathode and an interface with a second surface of the anode.

Embodiment 2. The molten carbonate fuel cell of Embodiment 1, further comprising an alkali carbonate electrolyte, the alkali carbonate electrolyte optionally being at least partially contained in pores of the cathode.

Embodiment 3. The molten carbonate fuel cell of Embodiment 2, wherein the alkali carbonate electrolyte comprises a molten alkali carbonate electrolyte, the molten alkali carbonate electrolyte being at least partially contained in the electrolyte matrix.

Embodiment 4. The molten carbonate fuel cell of Embodiment 2 or 3, wherein the alkali carbonate electrolyte comprises Na₂CO₃, Li₂CO₃, K₂CO₃, or a combination thereof.

Embodiment 5. A method for operating a molten carbonate fuel cell, the method comprising: introducing an anode input stream comprising H₂, a reformable fuel, or a combination thereof into an anode gas collection zone, the anode gas collection zone being defined by a first surface of an anode, a first separator plate, and an anode current collector providing support between the anode surface and the separator plate, the anode comprising a beginning-of-life porosity of 45% or more and a thickness of 0.30 mm or more; introducing a cathode input stream comprising O₂ and CO₂ into a cathode gas collection zone, the cathode gas collection zone being defined by a first surface of a cathode, a second separator plate, and a cathode current collector providing support between the cathode surface and the second separator plate; operating the molten carbonate fuel cell at an average current density of 60 mA/cm² or more and a CO₂ utilization of 60% or more to generate electricity, an anode exhaust comprising H₂, CO, and CO₂, and a cathode exhaust comprising 2.5 vol % or less CO₂, wherein an open area of the first surface of the cathode comprises 40% or more of a total surface area of the cathode surface, and wherein the molten carbonate fuel cell comprises an electrolyte matrix having an interface with a second surface of the cathode and an interface with a second surface of the anode, the electrolyte matrix comprising a molten alkali carbonate electrolyte.

Embodiment 6. The method of Embodiment 5, wherein the CO₂ utilization is 70% or more.

Embodiment 7. The method of Embodiment 5 or 6, wherein the voltage drop across the cathode is 0.4 V or less, or wherein the electricity is generated at a voltage of 0.55 V or more, or wherein the cathode inlet temperature is 550° C. to 650° C., or a combination thereof.

Embodiment 8. The method of any of Embodiments 5 to 7, wherein the cathode input stream comprises 5.0 vol % or less of CO₂, or wherein the cathode exhaust comprises 1.0 vol % or less of CO₂, or a combination thereof.

Embodiment 9. The method of any of Embodiments 5 to 8, wherein the cathode exhaust stream comprises 1.5 vol % or less of CO₂.

Embodiment 10. The method of any of Embodiments 5 to 9, wherein the alkali carbonate electrolyte comprises Na₂CO₃, Li₂CO₃, K₂CO₃, or a combination thereof.

Embodiment 11. The molten carbonate fuel cell or method of any of the above embodiments, wherein the thickness of the anode is 0.35 mm to 0.55 mm.

Embodiment 12. The molten carbonate fuel cell or method of any of the above embodiments, wherein the open area of the first surface of the cathode comprises 50% or more of the total surface area of the first surface of the cathode, or wherein a contact area of the cathode current collector with the first surface of the cathode is greater than 10% of the total surface area of the first surface of the cathode, or a combination thereof.

Embodiment 13. The molten carbonate fuel cell or method of any of the above embodiments, wherein a distance from any point on the cathode surface to an open area on the cathode surface is 1.0 mm or less, or wherein the average cathode gas lateral diffusion length is 0.35 mm or less, or a combination thereof.

Embodiment 14. The molten carbonate fuel cell or method of any of the above embodiments, further comprising an intermediate mesh layer between the cathode current collector and the first cathode surface, the cathode current collector providing support of the first surface of the cathode via the intermediate mesh layer.

All numerical values within the detailed description and the claims herein are modified by “about” or “approximately” the indicated value, and take into account experimental error and variations that would be expected by a person having ordinary skill in the art.

Although the present invention has been described in terms of specific embodiments, it is not necessarily so limited. Suitable alterations/modifications for operation under specific conditions should be apparent to those skilled in the art. It is therefore intended that the following claims be interpreted as covering all such alterations/modifications that fall within the true spirit/scope of the invention.

1. A molten carbonate fuel cell, comprising:
a first separator plate;
a cathode current collector;
a cathode, the cathode current collector providing support between the first separator plate and a first surface of the cathode, an open area of the first surface of the cathode comprising 40% or more of the total surface area of the first surface of the cathode;
a second separator plate;
an anode current collector;
an anode comprising a thickness of 0.30 mm or more and beginning-of-life porosity of 45% or more, the anode current collector providing support between the second separator plate and a first surface of the anode; and
an electrolyte matrix having an interface with a second surface of the cathode and an interface with a second surface of the anode.

2. The molten carbonate fuel cell of claim 1, wherein the thickness of the anode is 0.35 mm to 0.55 mm.

3. The molten carbonate fuel cell of claim 1, wherein the open area of the first surface of the cathode comprises 50% or more of the total surface area of the first surface of the cathode.

4. The molten carbonate fuel cell of claim 1, wherein a distance from any point on the cathode surface to an open area on the cathode surface is 1.0 mm or less.

5. The molten carbonate fuel cell of claim 1, wherein a contact area of the cathode current collector with the first surface of the cathode is greater than 10% of the total surface area of the first surface of the cathode.

6. The molten carbonate fuel cell of claim 1, further comprising an intermediate mesh layer between the cathode current collector and the first cathode surface, the cathode current collector providing support of the first surface of the cathode via the intermediate mesh layer.

7. The molten carbonate fuel cell of claim 1, wherein the average cathode gas lateral diffusion length is 0.35 mm or less.

8. The molten carbonate fuel cell of claim 1, further comprising an alkali carbonate electrolyte, the alkali carbonate electrolyte being at least partially contained in pores of the cathode.

9. The molten carbonate fuel cell of claim 8, wherein the alkali carbonate electrolyte comprises a molten alkali carbonate electrolyte, the molten alkali carbonate electrolyte being at least partially contained in the electrolyte matrix.

10. The molten carbonate fuel cell of claim 1, further comprising an alkali carbonate electrolyte, wherein the alkali carbonate electrolyte comprises Na₂CO₃, Li₂CO₃, K₂CO₃, or a combination thereof.

11. A method for operating a molten carbonate fuel cell, the method comprising:
introducing an anode input stream comprising H₂, a reformable fuel, or a combination thereof into an anode gas collection zone, the anode gas collection zone being defined by a first surface of an anode, a first separator plate, and an anode current collector providing support between the anode surface and the separator plate, the anode comprising a beginning-of-life porosity of 45% or more and a thickness of 0.30 mm or more;
introducing a cathode input stream comprising O₂ and CO₂ into a cathode gas collection zone, the cathode gas collection zone being defined by a first surface of a cathode, a second separator plate, and a cathode current collector providing support between the cathode surface and the second separator plate;
operating the molten carbonate fuel cell at an average current density of 60 mA/cm² or more and a CO₂ utilization of 60% or more to generate electricity, an anode exhaust comprising H₂, CO, and CO₂, and a cathode exhaust comprising 2.5 vol % or less CO₂,
wherein an open area of the first surface of the cathode comprises 40% or more of a total surface area of the cathode surface, and
wherein the molten carbonate fuel cell comprises an electrolyte matrix having an interface with a second surface of the cathode and an interface with a second surface of the anode, the electrolyte matrix comprising a molten alkali carbonate electrolyte.

12. The method of claim 11, wherein the thickness of the anode is 0.35 mm to 0.55 mm.

13. The method of claim 11, wherein the open area of the first surface of the cathode comprises 50% or more of the total surface area of the first surface of the cathode.

14. The method of claim 11, wherein a distance from any point on the cathode surface to an open area on the cathode surface is 1.0 mm or less.

15. The method of claim 11, wherein a contact area of the cathode current collector with the first surface of the cathode is greater than 10% of the total surface area of the first surface of the cathode.

16. The method of claim 11, wherein the average cathode gas lateral diffusion length is 0.35 mm or less.

17. The method of claim 11, wherein the CO₂ utilization is 70% or more.

18. The method of claim 11, wherein the voltage drop across the cathode is 0.4 V or less, or wherein the electricity is generated at a voltage of 0.55 V or more, or wherein the cathode inlet temperature is 550° C. to 650° C., or a combination thereof.

19. The method of claim 11, wherein the cathode input stream comprises 5.0 vol % or less of CO₂, or wherein the cathode exhaust comprises 1.0 vol % or less of CO₂, or a combination thereof.

20. The method of claim 11, wherein the cathode exhaust stream comprises 1.5 vol % or less of CO₂.
